(19) United States
(12) Patent Application Publication
(10) Pub. No.: US 2024/0046347 A1
(43) Pub. Date: Feb. 8, 2024

(54) MACHINE-LEARNING MODEL TO PREDICT LIKELIHOOD OF EVENTS IMPACTING A PRODUCT

(71) Applicant: Tide Platform Limited, London (GB)

(72) Inventor: Natalia Koupanou, London (GB)

(21) Appl. No.: 17/883,807

(22) Filed: Aug. 9, 2022

(30) Foreign Application Priority Data
Aug. 3, 2022 (GR) 20220100637

(51) Int. Cl. G06Q 40/02; G06N 5/00

(52) U.S. Cl. CPC G06Q 40/025; G06N 5/003

(57) ABSTRACT

A risk-evaluation model is trained using historical data to predict the likelihoods of future events in a future time period that impact a product. The time period may correspond to the time period over which the product is provided. On receiving a request for the product, the model is used to predict the likelihood of an event occurring and a recommendation of whether to provide the product is made to a provider of the product. The product may be provided based on the recommendation.

### CROSS REFERENCE TO RELATED APPLICATIONS

This application claims the right of priority based on Greece application serial no. 20220100637, filed Aug. 3, 2022, which is incorporated by reference.

### BACKGROUND

### 1. Technical Field

The subject matter described relates generally to machine-learning and, in particular, to a model for predicting the likelihood of future events that impact product.

### 2. Problem

When deciding what products to offer to a consumer, providers typically use a combination of rules a human judgment calls regarding whether a given product is suitable for a particular consumer. For example, in the financial sector, lenders evaluate the likelihood of whether the consumer will default on repayments in determining whether to offer the entity a loan and on what terms the loan is offered. However, in many instances the lender is operating on limited data. This is particularly true for many financial technology companies and other non-traditional banking services, many of which have been formed in the last five to ten years and thus have limited data on loan repayments and defaults for their customers. As a result of the lack of data, many existing processes for approving loans and other products have high error rates, which increases the cost of products for consumers, reduces profits for lenders, or both. Such processes may also have biases, which further reduce business efficiency.

### SUMMARY

In various embodiments, a computer-implemented method for providing a product includes receiving a product request. The product request identifies a consumer. The method also includes obtaining a prediction of a future event for the consumer that would impact the product. The prediction is generated by an iteratively-trained risk-evaluation model. The suitability of the product is evaluated using the prediction and the product may be provided to the consumer (or not) based on the suitability. In one embodiment, the product is a loan and the future event is that the consumer fails to pay membership fees for an account with the loan provider, which may be used as a proxy for the likelihood of the consumer defaulting on the loan. The iteratively-trained risk-evaluation model may be a random forest survival model.

### BRIEF DESCRIPTION OF THE DRAWINGS

FIG. 1 is a block diagram of a networked computing environment suitable for deployment of a risk-evaluation model, according to one embodiment.

FIG. 2 is a block diagram of the server of FIG. 1, according to one embodiment.

FIG. 3 is a flowchart of a method for training a machine-learning model to predict the likelihood of future events impacting a product, according to one embodiment.

FIG. 4 is a flowchart of a method for applying a machine-learning model to evaluate the likelihood of future events impacting a product, according to one embodiment.

FIG. 5 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Overview

As described previously, existing approaches used by providers to evaluate the suitability of products for specific consumers may be prone to biases and errors. Significant efficiencies may be realized by adopting data-based approaches to evaluating product suitability. In the following disclosure, for convenience and clarity, various embodiments are described that relate to evaluating the suitability of a consumer for a loan based on a likelihood of default. However, it should be appreciated that the same or similar techniques may be used to predict the likelihood of other events and corresponding impacts on the suitability of other products.

In one embodiment, payment of a periodic provider membership fee by a consumer is used as a proxy for the consumer defaulting on loan payments. A risk-evaluation model (e.g., a machine-learning survival model) is trained using historical membership payment data to predict the likelihoods of consumers failing to make membership payments in a future time period (e.g., the next six months). The time period may correspond to the time period over which a loan would be scheduled to be repaid to the provider. Thus, the likelihood of a consumer failing to make membership payments in the time period can be used as a proxy for the likelihood that the consumer will default on a loan during its lifetime.

Once deployed, the trained risk-evaluation model may be used by the provider to evaluate requests for new loans or identify good candidates to offer new loans. In one embodiment, a loan request may identify a consumer (e.g., with a consumer ID) and data regarding the identified consumer is provided to the trained risk-evaluation model, which outputs a risk metric indicating the likelihood that the consumer will fail to make membership payments in an upcoming time period (and thus a likelihood that the consumer will default on the loan). The user may be selected in response to the user indicating an interest in a loan, manually by an operator (e.g., a financial institution employee), as part of a periodic evaluation of a group of consumers (e.g., all consumers who have an account with a financial services provider), or any other suitable method. The risk metric may be used to evaluate the suitability of the consumer for the loan. The consumer may be offered a loan either automatically or by a human operator based on the evaluation (e.g., if the risk metric is below a threshold).

### Example Systems

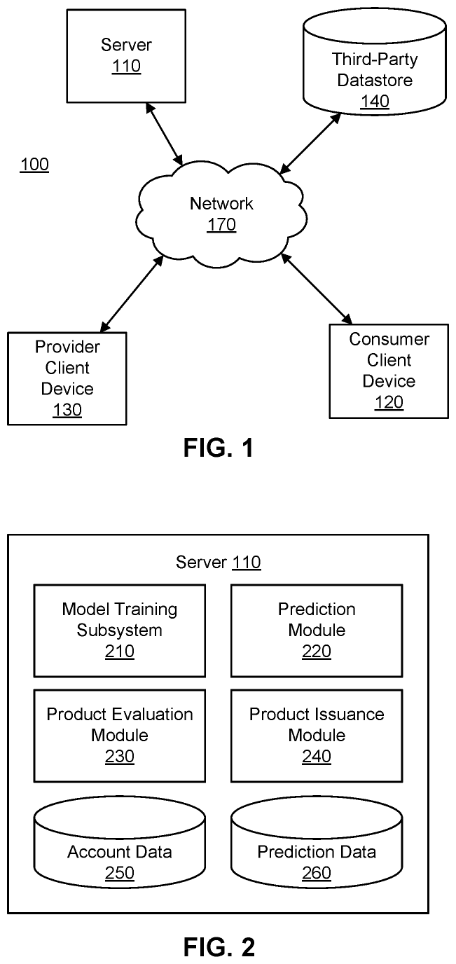

FIG. 1 illustrates one embodiment of a networked computing environment 100 in which the risk-evaluation model may be deployed. In the embodiment shown, the networked computing environment 100 includes a server 110, a consumer client device 120, a provider client device 130, and a third-party datastore 140, all connected via a network 170. In other embodiments, the networked computing environment 100 includes different or additional elements. Although only one consumer client device 120, provider client device 130, and third-party datastore 140 are shown, the networked computing environment 100 may include any number of such elements, or be omitted entirely. In addition, the functions may be distributed among the elements in a different manner than described. For example, the server 110 and the provider client device 120 may be provided by a single computer system.

The server 110 is one or more computing devices that apply a risk-evaluation model to consumer account data to evaluate the suitability of consumers for products (e.g., loans or other financial products). In one embodiment, the server 110 periodically (e.g., daily) applies the risk-evaluation model to data regarding consumers to generate risk metrics. The server 110 may proactively generate recommendations for consumers to whom loans should be offered based on the risk metric (e.g., if the risk metric is below a threshold). Alternatively, on receiving a request for a product (e.g., a loan) from a consumer, the server 110 may look up the corresponding pre-calculated risk metric and evaluate the suitability of the consumer for the loan. For example, the loan may have a repayment period (e.g., the next six months) and the risk metric may indicate a likelihood that the consumer will fail to pay membership fees to the provider during the repayment period. As described previously, this likelihood is a good proxy for the likelihood that the consumer will default on loan repayments. The server 110 may provide information regarding the suitability of the consumer for the loan to a human operator for approval or, in some embodiments, the loan may automatically be improved if one or more criteria are met (e.g., the risk metric being below a threshold). Various embodiments of the server 110 are described in greater detail below, with reference to FIG. 2.

A consumer client device 120 may be any computing device suitable for providing a user interface with which a consumer may interact with the server 110. The consumer is typically a business entity (but in some embodiments may also be an individual). It should be understood that references to actions taken by a business entity mean actions taken by a human on behalf of the business entity unless the context indicates otherwise. A consumer signs up for an account with the provider and is assigned or provides a unique identifier for the account (e.g., an account ID). The consumer may pay a periodic (e.g., monthly) membership fee for the account. The account may have an account balance of funds available with which the consumer may make payments, similar to a conventional bank account. As with a conventional bank account, the provider may provide financial services, such as the ability to make and receive payments, obtain loans, categorize payments and match them to receipts, and the like. In one embodiment, a consumer may use the user interface of the consumer client device 120 to request a product (e.g., a loan). The consumer client device 120 may send a request to the server 110 with an identifier of the consumer (e.g., a consumer ID). The consumer may also use the user interface to provide any additional information, communicate with an agent of the provider about the loan request, or review the status of the loan request, etc.

A provider client device 130 may be any computing device suitable for providing a user interface with which the provider may interact with the server 110. As with consumers, providers are typically business entities and references to actions taken by a business entity mean actions taken by a human on behalf of the business entity unless the context indicates otherwise. In one embodiment, an operator (e.g., an employee of the provider) may use a provider client device 130 to set up a batch process that periodically (e.g., daily or weekly) evaluates the suitability of consumers that have an account with the provider for one or more products. The provider client device 130 may also provide a user interface or otherwise notify the operator (e.g., via automatically generated emails) of consumers that are identified as good candidates for a product. (e.g., any consumer for which the server 110 calculates a risk metric below a threshold). Alternatively, the provider client device 130 may provide a user interface that includes a list of one or more pending loan requests submitted by consumers along with corresponding recommendations. The recommendation may be the risk metrics generated by the server 110 (e.g., a probability that the consumer will default on the loan) or a recommendation derived from the risk metrics (e.g., a binary yes/no indication determined by comparing the risk of default of a threshold). The user interface also includes one or more controls with which the provider may approve or deny the loan request. As described previously, in some embodiments, loans that meet one or more criteria may be approved automatically without human intervention.

The third-party datastore 140 includes one or more computer-readable media storing data about consumers. For example, the third-party datastore 140 may include credit rating agency data, companies house data, or any other data regarding consumers not originating or stored by the provider. The data in the third-party datastore 140 may be used as input to the risk-evaluation model instead of or as well as the consumer account data.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates one embodiment of the server 110. In the embodiment shown, the server 110 includes a model training subsystem 210, a prediction module 220, a product evaluation module 230, a product issuance module 240, account data 250, and prediction data 260. In other embodiments, the server 110 includes different or additional elements. In addition, the functions may be distributed among the elements in a different manner than described.

The model training subsystem 210 trains the risk-evaluation model to predict occurrence of events that impact product offerings by the provider. Although the model training subsystem 210 is shown as part of the server 110 for convenience, the model training subsystem may be a separate computing device that train the model which is then transferred to the server 110 (e.g., via the network 170). The risk-evaluation model takes input data describing a consumer as input and outputs one or more risk metrics indicating the likelihood that an event relating to the consumer that impacts the product will occur in a predetermined future time period. For example, the risk-evaluation model may calculate a likelihood that the consumer will fail to pay a membership fee in the next six months.

In various embodiments, the model training subsystem 210 uses some or all of the account data 250 as training data. Each account in the account data 250 belongs to a consumer and is identified by a unique identifier (e.g., an account ID or consumer ID). Account data 250 used as input to the model includes usage data, such as current balance, historical balances, median balance over a previous time period (e.g., thirty days), total value of credit transactions over the previous time period, total value of debit transactions over the previous time period, age of the account, time since the first transaction using the account, time since the last (e.g., most recent) transaction using the account, or any other metrics regarding usage and balances of the account. The model training subsystem 210 may also use additional input data relating to the consumer that holds the account, such as payment histories for one or more previous loans, credit agency data, or companies house data.

The account data 250 also includes payment data indicating whether membership fee payments were paid for the account that can be used as ground truth labels for training. The membership fee may be due periodically (e.g., weekly, monthly, or annually, etc.) for each account and the account data 250 indicates whether the fee has been paid each period. The account data 250 may also indicate whether any payments were late. Accounts that were involuntarily closed or downgraded due to failure to pay one or more fees on time may be considered examples of bad debt. Conversely, accounts that remain active at the original subscription level may be considered examples of good debt. In other words, each account may be labelled as equivalent to a loan for which payments were made or a loan that was defaulted on, depending on the membership fee payments made.

The model training subsystem 210 iteratively trains the model to predict whether membership fees will be paid for an account over a predetermined time period from the usage data of the account. Specifically, the model training subsystem 210 may use the model to predict whether membership payments were made for the accounts based on the input data, compare the predictions to the ground truth found in the payment data, and update the model by attempting to minimize a cost function that quantifies the aggregate difference between the predictions and ground truth. For example, each prediction may be a probability that the account will default (e.g., not make at least one membership fee payment) and the cost function may be the sum of the difference in squares between the predicted probability and the ground truth (zero if the membership fees were paid and one otherwise).

In one embodiment, the risk-evaluation model is a random survival forest model. The random survival forest may compute decision trees based on a log-rank test and estimate the cumulative hazard rate with the Nelson-Aalen estimator. The previous time period is broken up into a set of smaller time periods and the account data 250 indicates whether the membership fee was paid for each of the smaller time periods. For example, the time period may be six months and the membership fee may be due monthly, so the account data 250 may include an indication of whether the fee was paid for each of the six months. By using a random survival forest model, accounts with payment histories over different lengths of time may be compared (e.g., the default may be to look at the last six months of payments, but for accounts that are less than six months old, only those months in which membership payments were due may be considered. Random forest survival modeling automatically accounts for these differences in the length of time for which data is available.

Regardless of the precise nature of the model and training methods used, the output from the model training subsystem 210 is a trained risk-evaluation model that, given historical usage data for an account (and optionally additional data about the account or corresponding consumer) can predict the likelihood that membership fees will not be paid in an upcoming time period. This model may be stored for future use. The model may be periodically retrained as more training data becomes available (e.g., as more accounts are opened and more transactions take place).

The prediction module 220 applies the trained risk-evaluation model to predict the likelihood of events that impact products occurring for accounts. In one embodiment, the prediction module 220 periodically (e.g., daily, weekly, or monthly, etc.) predicts the likelihood that each account (or a subset of the accounts) will fail to pay a membership fee in an upcoming time period (e.g., the next month, six months, or year, etc.). The predicted likelihood for each account may be represented as one or more metrics, such as a percentage chance that the account will fail to make a payment at some point in the time period, a set of percentage chances that each of a set of payments corresponding to subdivisions of the time period (e.g., weeks or months) will be missed, or the like. By pre-calculating the predictions and storing them (e.g., in the prediction data 260), the prediction module 220 may enable more rapid evaluation of the risk of default for a newly requested loan. The pre-calculation may also be scheduled for times when there are fewer other demands on system resources (e.g., as part of a nightly update).

The product evaluation module 230 receives requests for products from consumers and generates recommendations relating to the requested products. In one embodiment, the product evaluation module 230 receives a request for a loan from a consumer client device 120. The request includes an identifier of the consumer such as a consumer ID or an account ID. The product evaluation module 230 obtains a prediction of whether the consumer will fail to make membership payments in an upcoming time period (e.g., the next six months). The prediction may be a pre-calculated prediction stored in the prediction data 260 or generated in response to the request. The product evaluation module 230 generates a recommendation to approve or deny the loan based on the prediction. For example, if the likelihood of the consumer failing to make membership payments in the upcoming time period is less than a threshold then the product evaluation module 230 may recommend approving the loan and recommend denying the loan otherwise.

The product issuance module 240 enables the product to be provided to the consumer based on the recommendation generated by the product evaluation module 230. In one embodiment, the product issuance module 240 provides a recommendation to approve or deny a loan for presentation to a human agent of the provider for final approval (e.g., in a user interface of a provider client device 130). Alternatively, in some instances, the loan may be automatically approved if the likelihood of the consumer not paying the membership fees is less than a second threshold, which may be the same or different from the threshold used to generate the recommendation. For example, a loan may be automatically approved if the likelihood of the consumer failing to make membership payments is less than a first threshold likelihood, presented to a human for approval if the likelihood is between the first threshold and a second threshold, and automatically denied if the likelihood is greater than the second threshold.

### Example Methods

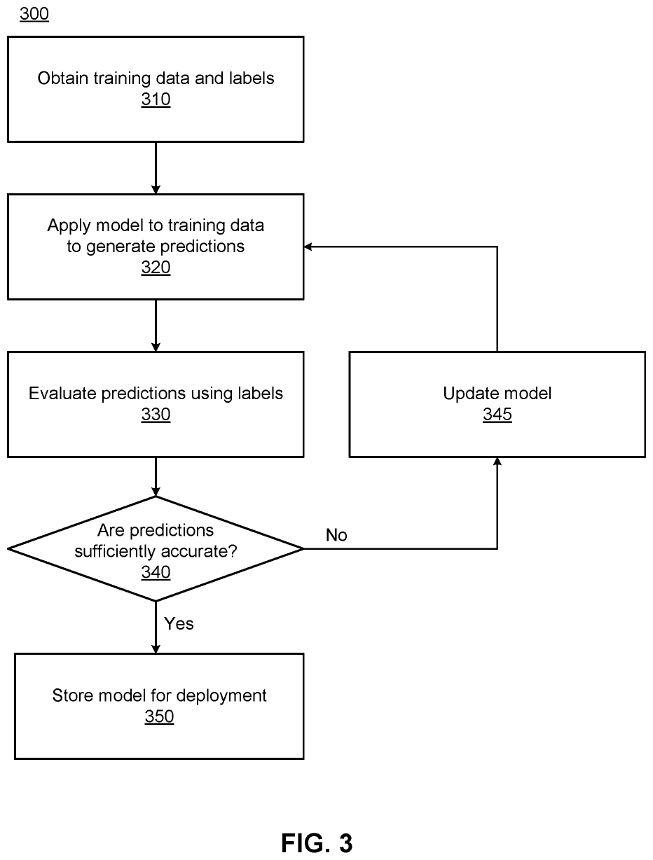

FIG. 3 illustrates a method 300 for training a machine-learning risk-evaluation model, according to one embodiment. The steps of FIG. 3 are illustrated from the perspective of the model training subsystem 210 performing the method 300. However, some or all of the steps may be performed by other entities or components. In addition, some embodiments may perform the steps in parallel, perform the steps in different orders, or perform different steps.

In the embodiment shown in FIG. 3, the method 300 begins with the model training subsystem 210 obtaining 310 training data and labels. The training data includes information about accounts. The labels in this context are data indicating whether membership fees were paid for the accounts over a time period. The model training subsystem 210 applies 320 the model to the training data to generate predictions and evaluates 330 using the labels. If the model can correctly predict whether membership fees were paid throughout the time period using other account information available at the start of the time period then the model is well fitted to the training data. If the predictions are being used simply to inform loan issuance decisions, calibration may not be required as a threshold may be set at any desired level of risk. Conversely, if the predictions are to be used for financial modeling (e.g., to predict a likelihood of default on a loan, and thus project losses due to defaults across a portfolio of loans), the predictions that membership fees will or will not be paid may be calibrated using historical default rates to give a more accurate measure of whether a consumer will default on a loan.

The model training subsystem 210 determines 340 whether the predictions are sufficiently accurate. This determination may be based on one or more metrics. For example, the model training system 210 may calculate the number of false positives (predictions that membership fees will not be paid when they were), the number of false negatives (predictions that membership fees would be paid when they were not), a number of correct predictions, the percentage of predictions that are correct, a number of incorrect predictions, the percentage of predictions that are incorrect, a precision score, a recall score, an F1 score, or any other metric indicative of how well the model is trained to match the training data. The model training subsystem 210 may compare the metrics to one or more criteria to determine 330 whether the predictions are sufficiently accurate. For example, in one embodiment, precision, recall, and F1 scores may all be required to be greater than corresponding thresholds for a determination that the predictions to be considered sufficiently accurate.

If the predictions are determined 340 to not be sufficiently accurate, the model training subsystem 210 updates 345 the mode. The model may be updated to reduce the error in the predictions using any suitable algorithm (e.g., a backpropagation algorithm). For example, the ensemble estimate for the cumulative hazard function generated by the model may be compared with historically observed default rates. This process iterates with the model being applied 320 to the training data, the resulting predictions being evaluated 330, and the model updated 345 until the model training subsystem 210 determines 340 that the predictions are sufficiently accurate (i.e., one or more accuracy criteria are met). Additionally or alternatively, the model may be trained for a fixed number of cycles before training ends. Regardless of the precise condition or conditions used to end training, the model is stored 350 for deployment.

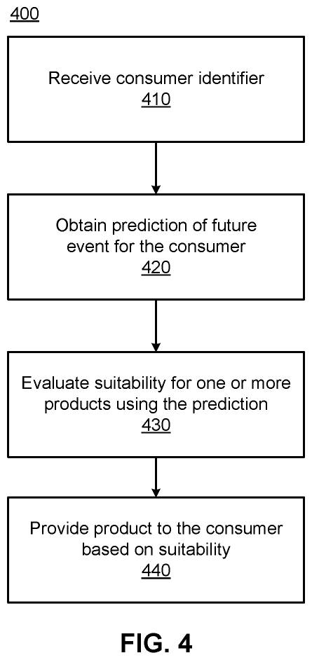

FIG. 4 illustrates a method 400 for applying the machine-learning risk-evaluation model to evaluate the likelihood of future events impacting a product, according to one embodiment. The steps of FIG. 4 are illustrated from the perspective of the product evaluation module 230 performing the method 400. However, some or all of the steps may be performed by other entities or components. In addition, some embodiments may perform the steps in parallel, perform the steps in different orders, or perform different steps.

In the embodiment shown in FIG. 4, the method 400 begins with the product evaluation module 230 receiving 410 a consumer identifier. The remainder of FIG. 4 will be described with reference to an embodiment in which the product is a loan but it should be understood that the method 400 may be applied to requests for other products. As described previously, the consumer identifier may be one included in a specific product request, provided by an operator, or generated as part of a batch evaluation process. The consumer may be identified directly (e.g., with a consumer ID) or indirectly (e.g., with an account ID for an account belonging to the consumer). For example, the identifier may be provided by a provider client device 130 or a consumer client device 120 in response to user input via a user interface of a financial app executing on the device. The identifier may be sent to the server 110 via the network 170. Alternatively, another module on the server 110 may provide the identifier to the product evaluation module 230 (e.g., as part of a periodic process of evaluating consumers to identify good candidates to offer a product).

The product evaluation module 230 obtains 420 a prediction of a future event for the consumer that is relevant to the product. In loan embodiment, the product evaluation module 230 obtains 420 a prediction of whether the consumer will default on the loan (e.g., a prediction of whether the consumer will fail to make membership fee payments, which is considered a proxy for loan default). The prediction may be precalculated (e.g., retrieved from the prediction data 260) or generated by a risk evaluation model in response to the request for the loan.

The product evaluation module 230 evaluates 430 the suitability of one or more products using the prediction. In the loan example, the product evaluation module 230 may compare a predicted likelihood that the consumer will default on the loan to a threshold to generate a recommendation of whether the loan should be approved. In some embodiments, the product evaluation module 230 generates recommendations for multiple products and selects one or more options for the consumer. For example, the product evaluation module 230 may consider loans with different term lengths or other conditions and recommend one most suited to the consumer (e.g., if the risk-evaluation model indicates the consumer is unlikely to default in the next six months but is more likely to default in six months to one year from the current date, the product evaluation module 230 may recommend a six-month loan but not a one year loan).

The product evaluation module 230 provides 440 a selected product to the consumer based on the evaluated suitability. In one embodiment, the product evaluation module 230 causes one or more recommended loans to be presented to a provider agent at a provider client device 130. The recommended products may be presented in a user interface with information explaining the recommendation, such as an analysis of the likelihood of the consumer defaulting over one or more time periods and other information about the consumer. Additionally or alternatively, a loan may be automatically approved or denied based on one or more criteria, as described previously.

### Computing System Architecture

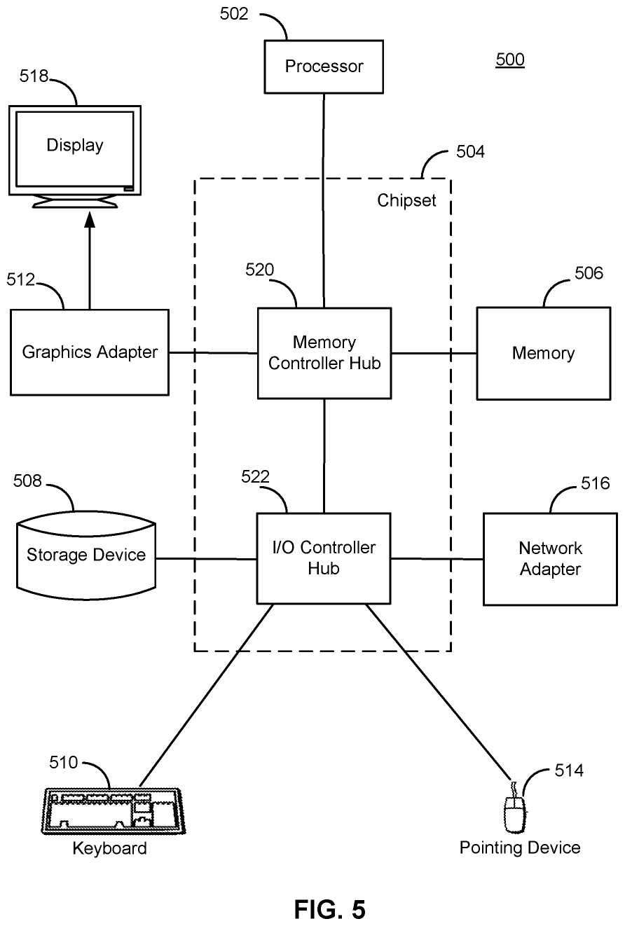

FIG. 5 is a block diagram of an example computer 500 suitable for use as a server 110, consumer client device 120, or provider client device 130. The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

In the embodiment shown in FIG. 5, the storage device 508 is a non-transitory computer-readable storage medium such as a hard drive, compact disk read-only memory (CD-ROM), DVD, or a solid-state memory device. The memory 506 holds instructions and data used by the processor 502. The pointing device 514 is a mouse, track ball, touch-screen, or other type of pointing device, and may be used in combination with the keyboard 510 (which may be an on-screen keyboard) to input data into the computer system 500. The graphics adapter 512 displays images and other information on the display 518. The network adapter 516 couples the computer system 500 to one or more computer networks, such as network 170.

The types of computers used by the entities of FIGS. 1 and 2 can vary depending upon the embodiment and the processing power required by the entity. For example, the server 110 might include multiple blade servers working together to provide the functionality described. Furthermore, the computers can lack some of the components described above, such as keyboards 510, graphics adapters 512, and displays 518.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process predicting the likelihood of events impacting a product. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
receiving an identifier of a consumer;
obtaining a prediction of a future event for the consumer that would impact a product, wherein the prediction was generated by an iteratively-trained risk-evaluation model;
evaluating a suitability of the product for the consumer using the prediction; and
providing, based on the suitability, an offer of the product to the consumer.

2. The computer-implemented method of claim 1, wherein the product is a loan, the identifier of the consumer is an identifier of an account of the consumer, and the prediction of the future event is a prediction that the consumer will default on the loan.

3. The computer-implemented method of claim 2, wherein the prediction that the consumer will default on the loan was generated by:
applying the risk-evaluation model to account data of the consumer to generate a likelihood that the consumer will fail to pay an account membership fee in a predetermined future period of time; and
using the likelihood that the consumer will fail to pay the account membership fee as a proxy for a probability that the consumer will default on the loan.

4. The computer-implemented method of claim 3, wherein a term length of the loan is the predetermined future period of time.

5. The computer-implemented method of claim 1, wherein the prediction includes a likelihood of the future event occurring, and evaluating the suitability of the product using the prediction comprises:
comparing the likelihood of the future event occurring to a threshold; and
recommending the product responsive to likelihood of the future event occurring being less than the threshold.

6. The computer-implemented method of claim 5, wherein providing the offer of the product to the consumer comprises:
causing a recommendation to provide the consumer with the product to be displayed at a provider client device; and
providing the offer of the product to the consumer responsive to approval received from the provider client device.

7. The computer-implemented method of claim 1, wherein providing the offer of the product to the consumer comprises:
comparing the likelihood of the future event occurring to a threshold; and
automatically providing the offer of the product to the consumer responsive to the likelihood of the future event occurring being less than the threshold.

8. The computer-implemented method of claim 1, wherein the iteratively-trained risk-evaluation model is a random forest survival tree.

9. The computer-implemented method of claim 8, wherein the prediction of the future event corresponds to a predetermined future time period, and the prediction comprises likelihoods of the future event occurring in each of a set of smaller time periods within the future time period.

10. The computer-implemented method of claim 1, wherein the iteratively-trained risk-evaluation model was trained by a process comprising:
obtaining account data describing use of accounts and labels indicating occurrence of events related to the accounts;
providing the account data as input to the iteratively-trained risk-evaluation model to generate event predictions;
evaluating the event predictions by comparing the event predictions to the labels; and
updating the iteratively-trained risk-evaluation model based on the evaluation of the event predictions.

11. The computer-implemented method of claim 10, wherein the process further comprises repeatedly providing the account data as input to the model to generate additional event predictions and evaluating the additional event predictions until one or more criteria are met.

12. The computer-implemented method of claim 10, wherein the account data for each account includes one or more of: a current balance, historical balances, a median balance over a previous time period, a total value of credit transactions over the previous time period, a total value of debit transactions over the previous time period, an age of the account, a time since a first transaction using the account, or a time since a most recent transaction using the account.

13. A non-transitory computer-readable medium storing executable computer program code that, when executed by a computing system, causes the computing system to perform operations comprising:
receiving an identifier of a consumer;
obtaining a prediction of a future event for the consumer that would impact a product, wherein the prediction was generated by an iteratively-trained risk-evaluation model;
evaluating suitability of the product using the prediction; and
providing, based on the suitability, an offer of the product to the consumer.

14. The non-transitory computer-readable medium of claim 13, wherein the product is a loan, the identifier of the consumer is an identifier of an account of the consumer, and the prediction of the future event is a prediction that the consumer will default on the loan, and wherein the prediction that the consumer will default on the loan was generated by:
applying the risk-evaluation model to account data of the consumer to generate a likelihood that the consumer will fail to pay an account membership fee in a predetermined future period of time; and
using the likelihood that the consumer will fail to pay the account membership fee as a proxy for a probability that the consumer will default on the loan.

15. The non-transitory computer-readable medium of claim 13, wherein:
the prediction includes a likelihood of the future event occurring;
evaluating the suitability of the product using the prediction comprises:
comparing the likelihood of the future event occurring to a threshold; and
recommending the product responsive to likelihood of the future event occurring being less than the threshold; and
providing the product to the consumer comprises:
causing a recommendation to provide the consumer with the product to be displayed at a provider client device; and
providing the product to the consumer responsive to approval received from the provider client device.

16. The non-transitory computer-readable medium of claim 13, wherein providing the offer of the product to the consumer comprises:
comparing the likelihood of the future event occurring to a threshold; and
automatically providing the offer of the product to the consumer responsive to the likelihood of the future event occurring being less than the threshold.

17. The non-transitory computer-readable medium of claim 13, wherein the iteratively-trained risk-evaluation model is a random forest survival tree, the prediction of the future event corresponds to a predetermined future time period, and the prediction comprises likelihoods of the future event occurring in each of a set of smaller time periods within the future time period.

18. The non-transitory computer-readable medium of claim 13, wherein the iteratively-trained risk-evaluation model was trained by a process comprising:
obtaining account data describing use of accounts and labels indicating occurrence of events related to the accounts;
providing the account data as input to the iteratively-trained risk-evaluation model to generate event predictions;
evaluating the event predictions by comparing the event predictions to the labels; and
updating the iteratively-trained risk-evaluation model based on the evaluation of the event predictions.

19. The non-transitory computer-readable medium of claim 18, wherein the process further comprises repeatedly providing the account data as input to the model to generate additional event predictions and evaluating the additional event predictions until one or more criteria are met.

20. The non-transitory computer-readable medium of claim 18, wherein the account data for each account includes one or more of: a current balance, historical balances, a median balance over a previous time period, a total value of credit transactions over the previous time period, a total value of debit transactions over the previous time period, an age of the account, a time since a first transaction using the account, or a time since a most recent transaction using the account.
